(19) United States
(12) Patent Application Publication
(10) Pub. No.: US 2009/0164829 A1
(43) Pub. Date: Jun. 25, 2009

(54) METHOD FOR INCREASING A PROGRAMMING SPEED FOR A TIME SIGNAL RECEIVER, PROGRAMMABLE TIME SIGNAL RECEIVER, AND PROGRAMMING DEVICE FOR PROGRAMMING A TIME SIGNAL RECEIVER

(76) Inventors: Roland Polonio, Neckarsulm (DE); Hans-Joachim Sailer, Heilbronn (DE)

Correspondence Address: Muncy, Geissler, Olds & Lowe, PLLC, P.O. BOX 1364, FAIRFAX, VA, 22038-1364, US

(21) Appl. No.: 11/962,085

(22) Filed: Dec. 20, 2007

Related U.S. Application Data
(60) Provisional application No. 60/876,528, filed on Dec. 22, 2006.

(30) Foreign Application Priority Data
Dec. 20, 2006 (DE) DE10 2006 060 926

(51) Int. Cl. G06F 5/06

(52) U.S. Cl. 713/600

(57) ABSTRACT

Method for increasing a programming speed for a time signal receiver, programmable time signal receiver, and programming device for programming a time signal receiver. The method for wireless programming of a time signal receiver provides the following steps: provision to the time signal receiver of a programming clock frequency that is selected to be higher than an internal operating clock frequency of the time signal receiver; provision of programming instructions for the time signal receiver by means of a programming device with a data rate that is matched to the programming clock frequency, decoding of the programming instructions by receiver and/or by processor of the time signal receiver, in particular at the rate of the programming clock frequency, storage in memory within the time signal receiver, in particular at the rate of the programming clock frequency, of the programming instructions intended for execution in the receiver and/or in the processor.

This nonprovisional application claims priority to German Patent Application No. DE 102006060926, which was filed in Germany on Dec. 20, 2006, and to U.S. Provisional Application No. 60/876,528, which was filed on Dec. 22, 2006, and which are both herein incorporated by reference.

### BACKGROUND OF THE INVENTION

1. Field of the Invention

The present invention relates to a method for increasing a programming speed for a time signal receiver, a programmable time signal receiver, and a programming device for programming a time signal receiver.

2. Description of the Background Art

The provision of an exact time reference is of elementary importance for a variety of applications in daily life. In various nations such as the USA, Japan, Russia, Germany, etc., precise time signals are provided by the responsible national authorities and can be received with the aid of suitable receivers (time signal receivers). The time signals can be used in appropriately equipped terminal devices, in particular in radio-controlled clocks or time-based measurement devices, for further processing, which is to say for extracting a precise time reference.

Radio waves, in particular in the long-wave frequency range from approximately 30 KHz to approximately 300 KHz, are a suitable medium for transmitting time signals. Time signals coded in long-wave signals, in particular by amplitude modulation, have a very long range, they penetrate buildings, and they can still be received with very small ferrite antennas. Obstructions such as trees and buildings cause severe signal attenuations for high-frequency satellite signals; in contrast, the reception of long-wave signals is only slightly degraded by such obstructions.

The time signal is provided by a time signal transmitter that transmits a signal sequence in accordance with a predetermined protocol. The national time transmitters differ in the selected transmit frequency as well as in the structure of the protocol. One example is the DCF77 time signal transmitter of the Physikalisch-Technische Bundesanstalt (PTB) [German national metrology institute], which is controlled by several atomic clocks and which continuously transmits a time signal with a power of 50 KW on the frequency 77.5 KHz. A more detailed description of the protocol for the time signal transmitted by the DCF77 station can be found in the description below of FIGS. 1 and 2. Examples of other time signal transmitters include WWVB (USA), MSF (United Kingdom), JJY (Japan), and BPC (China), which transmit time information on a long-wave frequency in the range between 40 and 120 KHz by means of amplitude-modulated signals.

Generally, a time signal with a time frame that is exactly one minute long is used for transmitting time information. This time frame contains values for the minute, hour, day, weekday, month, year, etc. in the form of BCD codes (binary-coded decimal codes), which are transmitted with pulse-width modulation at 1 Hz per bit. Here, either the rising edge or the falling edge of the first pulse of a time frame is precisely synchronized with 0 seconds. A typical radio-controlled clock is designed so that the time setting takes place by receiving the time information of one or more time frames starting from the point in time when the zero-seconds signal was first received.

FIG. 1 shows the coding scheme for the coded time information according to the protocol of the DCF77 time signal transmitter, labeled with reference symbol A. The coding scheme here consists of 59 bits, wherein each bit corresponds to one second of the frame. Thus, over the course of one minute, a so-called time signal message can be transmitted, containing information on the time and date in binary-encoded form. The first 15 bits B contain general coding, for example operational information, and are not used at present. The next 5 bits C contain general information. Thus, R represents the antenna bit, A1 represents a flag bit for switchover from Central European Time (CET) to Central European Summer Time (CEST) and back, Z1, Z2 represent zone time bits, A2 represents a flag bit for a leap second, and S represents a start bit for the coded time information. Time and date information is transmitted from the 21^{st} bit to the 59^{th} bit in BCD code, with the data applying to the following minute. Here, the bits in area D contain information on the minute, the bits in area E contain information on the hour, the bits in area F contain information on the calendar day, the bits in area G contain information on the day of the week, the bits in area H contain information on the month, and the bits in area I contain information on the calendar year. This information is present as bits in coded form. Check bits P1, P2, P3 are provided at the end of the respective areas D, E and I. The sixtieth bit is unassigned and is used to indicate the start of the next frame. M represents the minute mark and thus the start of the time signal.

The structure and bit allocations of the coding scheme for time signal transmission shown in FIG. 1 are generally known and are described, for example, in an article by Peter Hetzel, “Zeitinformation und Normalfrequenz, [time information and standard frequency],” in Telekom Praxis, Volume 1, 1993.

The time signal information is transmitted using amplitude modulation with the individual second markers. The modulation consists of a decrease X1, X2 or increase in the carrier signal X at the start of each second, where at the start of each second—except for the fifty-ninth second of each minute—in the case of a time signal transmitted by the DCF77 transmitter—the carrier amplitude is reduced to approximately 25% of the amplitude for a period of 0.1 second X1, or a period of 0.2 second X2. These decreases of different lengths each define second markers or data bits. These different lengths of the second markers are used for binary coding of time and date, where second markers with a duration of 0.1 second X1 correspond to a binary “Q,” and those with a duration of 0.2 second X2 correspond to a binary “1”. The next minute marker is indicated by the absence of the sixtieth second marker. Evaluation of the time information transmitted by the time signal transmitter is then possible in combination with the present second. FIG. 2 uses an example to show a portion of such an amplitude-modulated time signal, wherein the coding is accomplished by a decrease in the HF signal with differing pulse lengths.

Conventional time signal receivers, such as are described in German patent DE 35 16 810 C2, receive the amplitude-modulated time signal radiated by the time signal transmitter and output it in demodulated form as pulses of different lengths. This takes place in real time, which is to say that each second, a different-length pulse is produced at the output in accordance with the idealized time signal shown in FIG. 2. The time information is present here, encoded in the different-length pulses of the carrier. These different-length pulses are delivered by the time signal receiver to a following microcontroller. The microcontroller analyzes these pulses and, based on the length of each pulse, determines whether this pulse is assigned a bit value of “1” or “0.” This is accomplished by first identifying the beginning of the second of a relevant time frame of the time signal. Once this beginning of the second is known, the bit value “1” or “0” of each pulse can be determined from its determined duration. Subsequently, the microcontroller now receives all 59 bits of a minute, and determines the precise date and time on the basis of the bit coding of each seconds pulse.

There is known from the market a time signal receiver implemented as a radio-controlled clock with a radio-controlled clock movement, which is designed to receive a time signal. In order to make it possible to adapt the radio-controlled clock system to different operating conditions and, if necessary, permit lock or unlock functions of the radio-controlled clock system, the radio-controlled clock system is designed to be programmable. This means that one or more programming instructions encoded according to a programming protocol stored in the radio-controlled clock system can be entered into the radio-controlled clock system. Once they have been entered, the programming instructions are decoded and processed in the radio-controlled clock system in order to effect the desired characteristics of the radio-controlled clock system. Both the entry of the programming instructions and their decoding and processing are accomplished at a processing speed that is specified in the time signal receiver and is matched to the data rate of the time signal. Programming of a time signal receiver is typically accomplished with wired entry of programming instructions into the time signal receiver, and takes place at a data rate that is selected to correspond to the data rate of the time signal. This means that the transmission of programming instructions for a time signal receiver that is matched to a typical time signal transmitter requires a certain period of time, which becomes noticeable in a problematic fashion, especially when programming time signal receivers in mass production.

### SUMMARY OF THE INVENTION

It is therefore an object of the present invention to provide a method for programming a time signal receiver, a time signal receiver, and a programming device for programming a time signal receiver, which permit faster programming.

The inventive method for increasing a programming speed for a time signal receiver includes the following steps: provision to the time signal receiver of a programming clock frequency that is selected to be higher than an internal operating clock frequency of the time signal receiver; provision of programming instructions for the time signal receiver by means of a programming device with a data rate that is matched to the programming clock frequency; decoding of the programming instructions by receiver and/or by processor of the time signal receiver, in particular at the rate of the programming clock frequency; storage in memory within the time signal receiver, in particular at the rate of the programming clock frequency, of the programming instructions intended for execution in the receiver and/or in the processor. The desired acceleration of the programming process is achieved in that the internal processing speed of the time signal receiver, which is designed for the low data rate of the time signal and for low energy consumption, is overridden and thus increased by means of the programming clock frequency. Thus, with the aid of the programming clock frequency, which is chosen to be higher than the internal operating frequency, an adaptation of the time signal receiver to a higher data rate is achieved, at which rate the corresponding programming instructions can be provided by the programming device with greater speed. Thus, even for a programming clock frequency that is selected to be twice as high as the operating clock frequency, a halving of the programming time is achieved. This is of interest especially in the case where a large number of time signal receivers is to be programmed in mass production. A short programming time is also desired when a time signal receiver provided in an end-user device such as a wristwatch, a household appliance, or another device is to be programmed with customer-specific data, for example at the cash register in a shop. The programming clock frequency is preferably chosen so as to ensure an advantageous compromise between a short programming duration and reliable execution of the programming operation. On account of its structure and layout, the time signal receiver does not permit an arbitrary increase in the operating clock frequency. Preferably, at least a doubling, especially preferably a quadrupling, in particular a tenfold increase, of the operating frequency is provided.

Provision is made in the embodiment of the invention that the programming clock frequency is derived from a clock frequency provided internally in the time signal receiver, in particular from an internal clock generator. The operating frequency of a time signal receiver is typically derived from a significantly higher basic clock frequency. In one prior art time signal receiver, a frequency of approximately 32 kHz is provided by an internal clock generator implemented as a quartz-crystal oscillator, and is divided down to an internal operating clock frequency of 1024 Hz with the aid of frequency dividers. The receiver and/or the processor and/or the memory are operated at the operating clock frequency. By using a smaller division ratio on the basic clock frequency, it is simple to provide a higher internal clock frequency, which is then used as the programming clock frequency to transmit programming instructions at a higher data rate. The use of an internal clock frequency eliminates problems such as providing and transmitting an external programming clock frequency to the time signal receiver.

In further embodiment of the invention, provision is made that a programming signal provided by the programming device effects a switchover of a frequency switching device associated with the time signal receiver from the operating clock frequency to the programming clock frequency. The frequency switching device can be provided in order to differently drive an arrangement of frequency dividers, in particular a cascaded arrangement, which is to say connected in series, as a function of programming signals. In this regard, in the absence of a programming signal the frequency divider is driven such that the basic clock frequency is divided down to the operating clock frequency. In the presence of the programming signal, one or more frequency dividers is driven by the frequency switching device such that they perform no further division of the basic clock frequency, so that a higher clock frequency can be output. Alternatively, the clock frequency is coupled out by the frequency switching device before passing through any frequency dividers of a frequency divider arrangement in order to obtain a clock signal with a higher clock frequency. In another embodiment of the invention, the frequency switching device is provided for switching between two or more internal clock generators whose basic clock frequencies, which differ from one another, can alternately be directed in alternation through a frequency divider arrangement in order to provide the operating clock frequency or the programming clock frequency.

In further embodiment of the invention, provision is made that a switchover in the frequency switching device from a first frequency divider having a higher division ratio to a second frequency divider having a lower division ratio is effected by the programming signal. In this way, a simple structure of the time signal receiver can be implemented, since the frequency dividers need not be designed to be switchable, but instead the frequency switching device appropriately feeds the basic clock frequency to the first or second frequency divider.

In further embodiment of the invention, provision is made that the programming clock frequency is provided by the programming device. By this means, the provision of different internal clock generators, frequency dividers or frequency switching devices in the time signal receiver can be avoided, ensuring that the construction of the time signal receiver is especially economical. Rather, the programming clock signal is fed into the time signal receiver from outside in such a manner that the operating clock signal is overridden and programming can take place at a higher data rate.

In further embodiment of the invention, provision is made that the programming clock frequency is transmitted wirelessly to the time signal receiver by the programming device. In this way, a number of time signal receivers can simultaneously be supplied with the programming clock signal for rapid execution of the programming process. This is especially the case when the programming instructions are also transmitted wirelessly to the time signal receiver by the programming device.

In further embodiment of the invention, provision is made that the programming clock frequency is transmitted by wire to the time signal receiver by the programming device. Especially in combination with transmission of the programming instructions to the time signal receiver by wire, this allows individual adaptation of the programming clock frequency and the data rate of the programming instructions to the boundary conditions of the time signal receiver. As a result of information transmission by wire (programming clock frequency and/or programming instructions) between the programming device and the time signal receiver, feedback of information, e.g. a condition signal, from the time signal receiver to the programming device can also be implemented without additional devices in the time signal receiver. Such feedback makes it possible, for example, to provide information as to whether the programming instructions entered into the time signal receiver at a specified data rate were fully and correctly decoded and processed. Thus, dynamic matching of the programming clock frequency can be performed without additional devices at the time signal receiver, so that an average duration of the programming operations can be optimally adapted over a large number of time signal receivers of the same type that are to be programmed, achieving an additional time savings.

According to an additional aspect of the invention, there is provided a programmable time signal receiver having receiver designed for receiving an electromagnetic time signal and a programming signal, and having processor designed for processing the electromagnetic time signal and the programming signal, wherein the receiver and/or the processor have associated with them memory designed for temporary storage of instructions and for providing the instructions to the receiver and/or the processor. Also provided are frequency switching means designed for providing at least two different clock frequencies for the time signal receiver, wherein the time signal receiver is set up to carry out the process according to one of claims 1 through 9. The frequency switching means permit a switchover between the operating clock frequency and the programming clock frequency as a function of a programming signal provided by the programming device, and thus an adaptation of the time signal receiver to different data rates upon reception of a time signal or programming instructions.

In further embodiment of the invention, provision is made that at least one internal clock generator has associated with it at least two frequency dividers that are controllable by the frequency switchover device and that have different division ratios. Using the two frequency dividers, the lower operating clock frequency or the higher programming clock frequency can be provided selectably to the time signal receiver by control via the frequency divider switchover device. The frequency switchover device can preferably be set up such that, depending on the presence or absence of the programming signal, it routes the basic clock frequency generated by the internal clock generator to the one or the other of the at least two frequency dividers. Both frequency dividers, in turn, are connected to the receiver and/or the processor and/or the memory in order to provide the relevant clock signal to these devices. Also possible is a combination of multiple internal clock generators, wherein at least one of the internal clock generators has at least two frequency dividers associated with it, so that a total of at least three different clock frequencies can be provided.

In further embodiment of the invention, provision is made that an internal clock generator has associated with it a frequency divider that is variably settable by the frequency switchover device to different division ratios. A variably settable frequency divider can be designed to provide a continuously tunable clock frequency or to provide different but permanently predefined division ratios and the clock frequencies associated therewith. Preferably, the frequency divider is designed for at least two different but permanently predefined clock frequencies in order to achieve a simple structure of the time signal receiver.

In further embodiment of the invention, provision is made that the frequency switchover device is set up to switch between an external programming clock frequency, coupled in wirelessly or by wire, and an internal operating clock frequency provided by the internal clock generator. This makes it possible to couple an external programming clock frequency into the time signal receiver. The frequency switchover device is set up so as to avoid a collision between the programming clock frequency that is coupled in wirelessly or by wire from outside and the internal operating clock frequency.

According to an additional aspect of the invention, there is provided a programming device for programming a time signal receiver, having memory for storing programming instructions for the time signal receiver; having an internal clock generator for providing a programming clock frequency intended for the time signal receiver; and having a control unit that is set up for providing [programming] instructions to the time signal receiver. With such a programming device, by coupling a programming clock frequency into the time signal receiver, an acceleration of the programming can be achieved by raising the data rate that can be processed.

In further embodiment of the invention, provision is made that a transmitting device, in particular a long-wave transmitting device, for wirelessly providing programming instructions according to a protocol of the time signal receiver, and/or a programming clock frequency, is provided; and/or that an interface device for providing by wire programming instructions according to a protocol of the time signal receiver, and/or a programming clock frequency, is provided. In this way, wireless transmission of the programming instructions and/or the programming clock frequency can be provided. In addition or alternatively, it is also possible for the programming clock signal and/or the programming instructions to be provided by wire. In this way, the programming device can advantageously be adapted to the characteristics of the time signal receivers that are to be programmed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 a schematic graphic representation of a time signal which is coded according to the protocol of the DCF77 time signal transmitter;

FIG. 2 a section of an idealized time signal with 5 seconds pulses;

FIG. 3 a block diagram of a greatly simplified time signal receiver,

FIG. 4 a detailed block diagram of a part of the time signal receiver from FIG. 3;

FIG. 5 a schematic representation of a wired programming device that is set up to provide an external programming clock signal; and

FIG. 6 a schematic representation of a programming device for wireless transmission of programming instructions and a time signal receiver matched thereto.

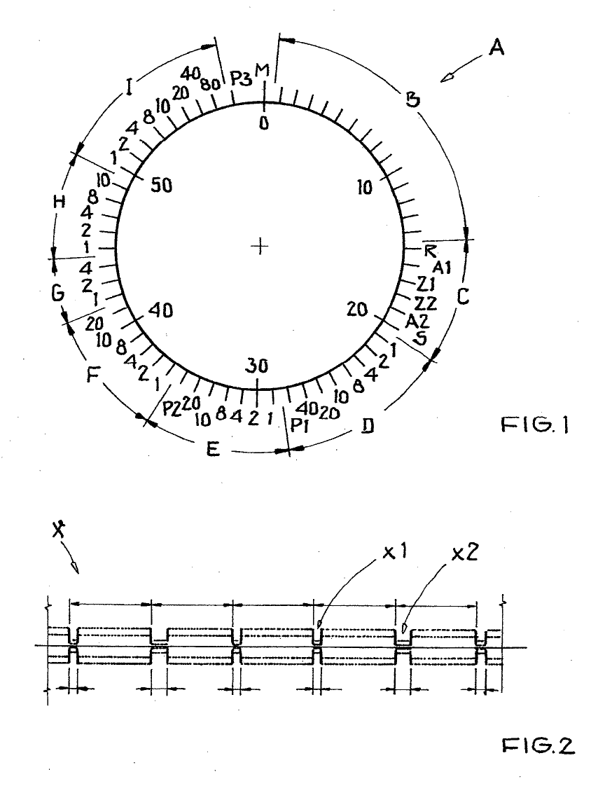

### DETAILED DESCRIPTION

In all drawing figures, like or functionally like elements, signals and functions are labeled identically, unless otherwise specified.

The basic structure and principle of operation of a time signal receiver is known from German patent DE 35 16 810. FIG. 3 shows a block diagram of a greatly simplified time signal receiver, which in the present case is embodied as a radio-controlled clock 100. The radio-controlled clock 100 has an antenna 2 for receiving the time signals 3 transmitted by a time signal transmitter 101. An integrated circuit 20 with a logic and control unit 30 is connected to the antenna 2. Antenna 2 and integrated circuit 20 together form the receiver 1. Following the outputs of the receiver 1 is a program-controlled unit implemented as a microcontroller 102 in the manner of processor. The microcontroller 102 receives the data bits produced by the receiver, calculates an exact time and date therefrom, and generates therefrom a signal 105 for time and date. The radio-controlled clock 100 also has an electronic clock 103 whose time is controlled on the basis of a quartz clock crystal 104. The electronic clock 103 is connected to a readout 106, for example a display, by means of which the time is displayed.

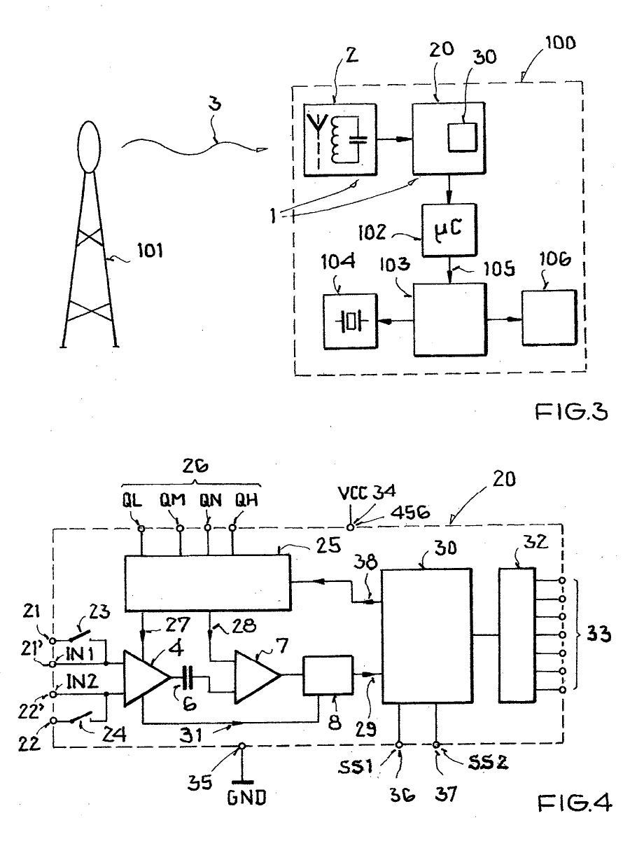

Using a detailed block diagram, FIG. 4 shows the part of the time signal receiver implemented as an integrated circuit 20. The integrated circuit 20 has two inputs 21, 22 for connection to one or two antennas that are not shown. Providing two or even more antennas makes it possible to tune the receiver 1 to different time signal transmitters operating in different wavelength ranges by switching between the antennas. A frequency or antenna switchover can be accomplished with the switchover. An AGC amplifier 4 can be connected to either of the antenna inputs 21, 22 by means of the controllable switches 23, 24. The other input of the AGC amplifier 4 is connected to inputs 21′, 22′. A reference signal IN1, IN2 can be coupled into these inputs, for example. On the output side, the AGC amplifier 4 is connected to an input of a post-amplifier 7. Arranged between them is a filter 6 designed in the form of a capacitor, with which parasitic capacitances between the inputs QL-QH can be compensated.

The integrated circuit 20 also has a switch unit 25. The switch unit 25 has, for example, multiple switchable filters at the inputs QL-QH, by means of which the switch unit 25 is designed to provide multiple frequencies at its output side. These frequencies can be set by means of control inputs 26, 36, 37 of the switch unit 25. The AGC amplifier 4 can be influenced, and in particular controlled, by a control signal 27 provided by the switch unit 25. The switch unit 25 also generates an output signal 28 that is coupled into a second input of the post-amplifier 7. The post-amplifier 7 drives the rectifier 8 that follows it. The rectifier 8 generates a control signal 31 (AGC signal=Automatic Gain Control) that drives the AGC amplifier 4. The rectifier 8 also generates at its output side an output signal 29, for example a square-wave output signal 29 (TCO signal), which is delivered to a logic and control unit 30 that follows it.

The logic and control unit 30 is connected to an input/output unit 32 (S/O unit), which is connected to input/output terminals 33 of the integrated circuit 20. Among other things, the time signals processed, decoded and stored in the logic and control unit 30 can be accessed at these outputs 33. A microcontroller or simple state machine—not shown in FIG. 4—that follows the integrated circuit 20 can also read out these time signals, stored and decoded in the logic and control unit 30, as needed. In addition, a clock signal can be provided to the integrated circuit 20 or the logic and control unit 30 through the terminals 33.

For further control of the switch unit 25, this unit is connected to the logic and control unit 30 and drives the logic and control unit 30 with a control signal 38. The integrated circuit also has terminals 36, 37, through which control signals SS1, SS2 can be applied to the logic and control unit 30.

FIG. 5 shows a programming device 202 that is intended for wired programming of a time signal receiver 120 implemented as a radio-controlled wristwatch. The programming device 202 has several adjusting knobs 220, 230 intended for adjusting the programming operation or for adjusting the functions to be unlocked in the time signal receivers. The programming device 202 is equipped with a signal cable whose end is provided with a contact plug 250. The contact plug is designed to electrically connect to a suitably designed contact device 70 on the time signal receiver 120, and permits the transmission of programming instructions and of a programming clock signal from the programming device 202 to the time signal receiver 120.

The time signal receiver 120 has the same subassemblies as the time signal receiver 100 shown in FIG. 3, but is also equipped with an additional internal clock generator 72 and the contact device 70.

The programming clock signal is provided by an oscillator 252 located in the programming device 202 and is fed into the integrated circuit 20 such that it can effect the desired increase in the receivable data rate there and in the microcontroller 102 that follows. The internal clock generator 72 that is intended to provide an operating clock signal and that is implemented as a quartz-crystal oscillator is connected to the receiver 1 and also to the microcontroller 102, and provides a basic clock frequency that is divided down to the operating clock frequency by frequency dividers that are not shown. The internal clock generator 72 can be temporarily decoupled from the receiver 1 by a switching device, symbolically represented as a switch 74, during execution of the programming operation, in order to avoid a collision between the operating clock frequency and the programming clock frequency provided by the programming device 202.

The external programming clock signal provided by the oscillator 252 in the programming device 202 can be variably settable with the aid of frequency dividers that are not shown, or can be output to the time signal receiver 120 as a permanently predefined programming clock frequency.

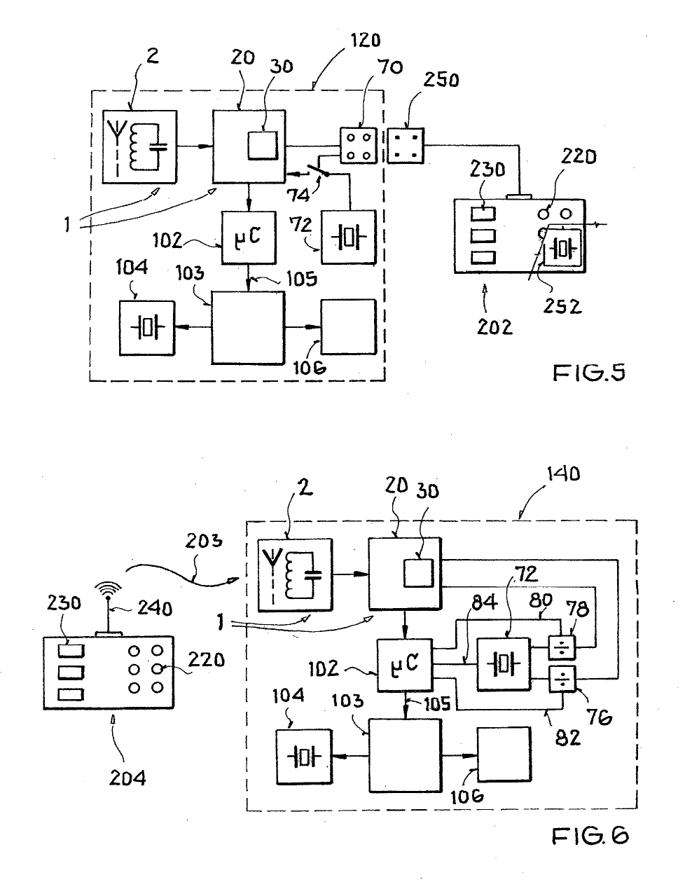

The programming device 204 shown in FIG. 6 is intended for wireless transmission of programming instructions, and has an antenna 240 that permits transmission of electromagnetic signals to the time signal receiver 140 without a mechanical connection between the programming device 204 and the time signal receiver 140. The time signal receiver 140 is equipped with an internal clock generator 72, designed as a quartz-crystal oscillator, that is intended to provide a basic clock signal. The internal clock generator 72 has associated with it two schematically represented frequency dividers 76 and 78, which have different division ratios and thus can derive an operating clock frequency and a programming clock frequency from the basic clock frequency of the internal clock generator 72 and deliver them to the receiver 1.

The microcontroller 102 is connected to the integrated clock generator 72 through a control line 84, thus permitting activation or deactivation of the internal clock generator 72. Deactivation of the internal clock generator 72 can be provided when, along with programming instructions, the programming device 204 wirelessly transmits an external clock signal that can be coupled into the receiver 1 and the microcontroller 102 through the antenna 2.

As long as no corresponding programming clock signal is provided by the programming device 204, the internal clock generator 72 remains activated during the programming operation. Upon receiving a corresponding programming instruction, the first frequency divider 76, designed to provide the operating clock signal, is deactivated by the microcontroller 102, and the second frequency divider 78, designed to provide the programming clock signal, is activated. In this way, the higher programming clock frequency is provided to the receiver 1 and thus also to the microcontroller 102, and reception of programming instructions from the programming device 204 can take place at a data rate that is higher than the data rate of the time signal.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for increasing a programming speed for a time signal receiver, the method comprising:
providing to the time signal receiver a programming clock frequency that is selected to be higher than an internal operating clock frequency of the time signal receiver;
providing programming instructions for the time signal receiver by a programming device with a data rate that is matched to the programming clock frequency;
decoding the programming instructions by a receiver and/or by processor of the time signal receiver at the rate of the programming clock frequency;
storing in a memory within the time signal receiver at the rate of the programming clock frequency of the programming instructions intended for execution in the receiver and/or in the processor.

2. The method according to claim 1, wherein the programming clock frequency is derived from a clock frequency provided internally in the time signal receiver, in particular from an internal clock generator.

3. The method according to claim 2, wherein a programming signal provided by the programming device effects a switchover of a frequency switching device associated with the time signal receiver from the operating clock frequency to the programming clock frequency.

4. The method according to claim 3, wherein a switchover in the frequency switching device from a first frequency divider having a higher division ratio to a second frequency divider having a lower division ratio is effected by the programming signal.

5. The method according to claim 1, wherein the programming clock frequency is provided by the programming device.

6. The method according to claim 5, wherein the programming clock frequency is transmitted wirelessly to the time signal receiver by the programming device.

7. The method according to claim 5, wherein the programming clock frequency is transmitted by wire to the time signal receiver by the programming device.

8. The method according to claim 1, wherein the programming instructions are transmitted wirelessly to the time signal receiver by the programming device.

9. The method according to claim 1, wherein the programming instructions are transmitted by wire to the time signal receiver by the programming device.

10. A programmable time signal receiver comprising:
a receiver for receiving an electromagnetic time signal and a programming signal;
a processor for processing the time signal and the programming signal, the receiver and/or the processor having an associated memory for temporary storage of instructions and for providing the instructions to the receiver and/or the processor;
a frequency switch for providing at least two different clock frequencies for the time signal receiver.

11. The programmable time signal receiver according to claim 10, wherein at least one internal clock generator has associated with it at least two frequency dividers that are controllable by the frequency switchover device and that have different division ratios.

12. The programmable time signal receiver according to claim 10, wherein an internal clock generator has associated with it a frequency divider that is variably settable by the frequency switchover device to different division ratios.

13. The programmable time signal receiver according to claim 10, wherein the frequency switchover device is set up to switch between an external programming clock frequency, coupled in wirelessly or by wire, and an internal operating clock frequency provided by the internal clock generator.

14. A programmable device for programming a time signal receiver, comprising:
a memory for storing programming instructions for the time signal receiver;
an internal clock generator for providing a programming clock frequency that is intended for programming the time signal receiver; and
a control unit that is set up for providing instructions to the time signal receiver.

15. The programmable device according to claim 14, further comprising:
a transmitting device, in particular a long-wave transmitting device, for wirelessly providing programming instructions according to a protocol of the time signal receiver, and/or for wirelessly providing a programming clock frequency; and
an interface device for providing by wire programming instructions according to a protocol of the time signal receiver, and/or for providing by wire a programming clock frequenc.
